(19) United States
(12) Patent Application Publication
(10) Pub. No.: US 2019/0226251 A1
(43) Pub. Date: Jul. 25, 2019

(54) Locking Device to Secure a Door and Methods of Installing and Operating the Locking Device

(71) Applicant: James Edward Crosser, Paris, TN (US)

(72) Inventor: James Edward Crosser, Paris, TN (US)

(21) Appl. No.: 16/268,486

(22) Filed: Feb. 5, 2019

Related U.S. Application Data
(60) Provisional application No. 62/619,878, filed on Jan. 21, 2018.

(51) Int. Cl. E05C 19/00

(52) U.S. Cl. CPC E05C 19/005; E05Y 2900/132

(57) ABSTRACT

A door locking device having a first rotatable handle affixed to a door, a rotatable member affixed to the door, a catch affixed to a surface adjacent the door to receive the rotatable member, and a protrusion from the first rotatable handle configured to lift the rotatable member when the rotatable member is engaged with the catch and the first rotatable handle is rotated.

A device to secure a moveable door, the device having a movable member affixed to the door, the movable member configured to engage a catch, a tab extending from the door, the tab configured to engage a cavity, and a first rotatable handle affixed to the door, rotation of the first rotatable handle retracting the tab so that the tab is no longer engaged with the cavity and moving the movable member so that the movable member is no longer engaged with the catch.

### CROSS REFERENCE TO RELATED APPLICATIONS

This application claims the benefit of U.S. Provisional Application No. 62/619,878, filed Jan. 21, 2018, which is hereby incorporated by reference.

### FIELD OF THE INVENTION

The invention relates to a device for securing a door and methods of installing and operating the device.

### BACKGROUND OF THE INVENTION

Doors have long been used to define entrances to certain areas or enclosed spaces. Various mechanisms can be used in conjunction with doors to restrict access to these areas and spaces. For example, doors have long been fitted with keylocks and bolt locks to prevent unauthorized persons from accessing a particular area or space.

Known locking mechanisms for doors are cumbersome to operate and often create a safety hazard, because they impede the quick movement of persons into and out of a space or room. This is especially true in environments like schools, hospitals, churches and the like. In fact, there are laws and codes that often prohibit the use of many of today's locking mechanisms on certain doors. For example, local fire codes may prohibit the use of certain locks on some doors, because the locks may impede the flow of people trying to escape an emergency, such as a fire.

Not only are many of today's locking mechanisms cumbersome to unlock, but they are cumbersome to lock, which also creates a safety hazard. A delay in activating a locking mechanism for a door may allow unauthorized persons to access an area or space. For example, a delay in activating a locking mechanism in an active shooter situation may allow the shooter to easily enter areas or spaces where many targets are present. For these reasons, there is a need for a locking mechanism for a door that can be quickly and easily activated and deactivated.

### SUMMARY OF THE INVENTION

In various exemplary embodiments, the device for securing a door comprises a rotatable handle affixed to a door, a rotatable member affixed to the door, a catch, and a protrusion from the rotatable handle that is configured to lift the rotatable member when the rotatable member is engaged with the catch and the rotatable handle is rotated.

In various exemplary embodiments, the method of operating a device for securing a door comprises rotating a handle affixed to a door, the handle comprising a protrusion, the protrusion moving a member that is affixed to the door so that the member is no longer engaged with a catch.

In various exemplary embodiments, the method of installing a device for securing a door comprises affixing a member to a door so that the member can rotate, the door having a handle, affixing a catch to a surface adjacent the door, the catch configured to receive the member, affixing a protrusion to the handle, the protrusion configured to lift the member when the member is engaged with the catch and the handle is rotated.

In various exemplary embodiments, the device to secure a moveable door comprises a movable member affixed to the door, the movable member configured to engage a catch, a tab extending from the door, the tab configured to engage a cavity, and a first rotatable handle affixed to the door, rotation of the first rotatable handle retracting the tab so that the tab is no longer engaged with the cavity and moving the movable member so that the movable member is no longer engaged with the catch.

### BRIEF DESCRIPTION OF THE DRAWINGS

FIG. 1 shows a first front view of a first embodiment of the invention.

FIG. 2 shows a rear view of the first embodiment.

FIG. 3 shows a side view of the wall from the perspective of someone standing in the doorway.

FIG. 4 shows a side view of the door from the perspective of someone standing in the doorway.

FIG. 5 shows a second front view of the first embodiment of the invention.

FIG. 6 shows a front view of a second embodiment of the invention.

FIG. 7 shows a front view of a third embodiment of the invention.

FIG. 8 shows a front view of a fourth embodiment of the invention.

FIG. 9 shows a front view of a prior art door.

### DETAILED DESCRIPTION

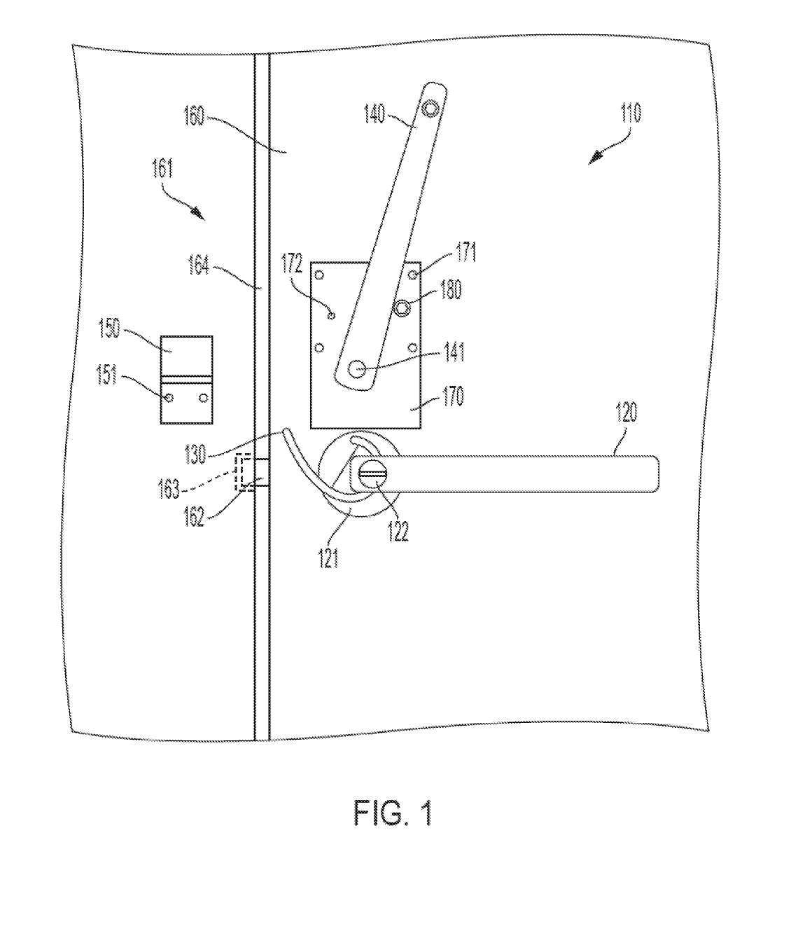

FIG. 1 shows a first front view of a first embodiment of door lock 110 of the present invention. In this embodiment, door lock 110 is used with a common door 160. Door 160 includes a tab 162 that engages with a cavity 163 in wall 161 to prevent door 160 from opening. Rotating first handle 120 retracts tab 162 so that tab 162 is no longer engaged with cavity 163, allowing a user to open door 160. In this figure, door 160 swings inward to open. Elevated ridge 164 of wall 161 prevents door 160 from opening outward.

In this embodiment, first handle 120 is elongated. Affixed to first handle 120 is protrusion 130. Door lock 110 also includes bar 140 and catch 150. Bar 140 is movably connected to door 160. Catch 150 is affixed to wall 161. In this embodiment, bar 140 is connected to door 160 through mounting plate 170 and pin 141, and catch 150 is affixed to wall 161 through screws 151. Mounting plate 170 includes stop 180 and screws 171 for affixing mounting plate 170 to door 160. In alternative embodiments, bar 140 is movably connected to door 160 without the use of mounting plate 170 and/or through additional components. As discussed further below, the use of mounting plate 170 allows door lock 110 to be more easily installed on a range of existing doors 160. For this reason, mounting plate 170 also includes preset hole 172 so that the position of stop 180 can be moved if door lock 110 is installed on another door. In additional alternative embodiments, protrusion 130 need not be affixed to first handle 120 but may be a design feature of first handle 120 itself.

In FIG. 1, bar 140 is in an open position and does not engage catch 150 to prevent door 160 from opening. Stop 180 is affixed to door 160 and limits bar 140's range of movement. In this embodiment, stop 180 is positioned to hold bar 140 in an open position until a user moves bar 140 to a closed position with his hand. Stop 180 also prevents bar 140 from moving clockwise and interfering with operation of first handle 120. In this embodiment, stop 180 is located so as to minimize the possibility that bar 140 will fall into the closed position unintentionally when door 160 is opened and closed, but also so as to allow a user of door lock 110 to quickly move bar 140 into the closed position with the user's hand.

Protrusion 130 moves with first handle 120 but does not engage bar 140 when bar 140 is in the open position. When bar 140 is in an open position a user standing on the near side of door 160 can turn first handle 120 and pull door 160 open. When bar 140 is in an open position a user standing on the near side of door 160 can push door 160 shut. When bar 140 is in an open position a user standing on the far side of door 160 can turn a second handle 180 on the far side of door 160 and push door 160 open. When bar 140 is in an open position a user standing on the far side of door 160 can pull door 160 shut.

Wall 161 also includes elevated ridge 164. Elevated ridge 164 acts as a barrier, preventing door 160 from opening outward. Elevated ridge 164 may be unitary with wall 161 or may comprise a component of wall 161, such a trim. First handle 120 also includes covering plate 121 and tab lock 122 for locking door 160.

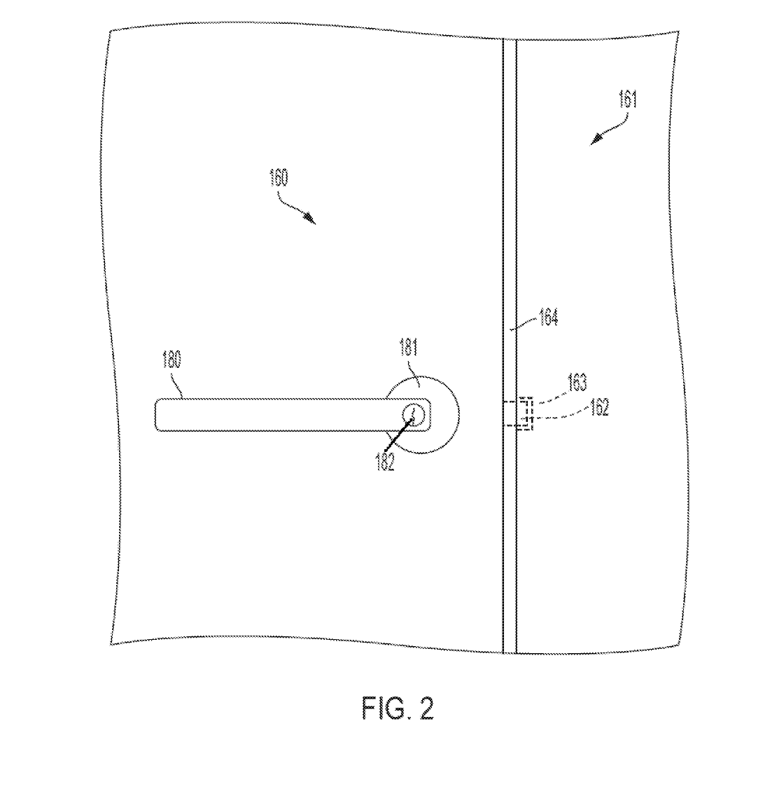

FIG. 2 shows a rear view of door 160. Door 160 includes second handle 180. Second handle 180 includes a covering plate 181 and a keyhole 182 for locking and unlocking door 160 with a key.

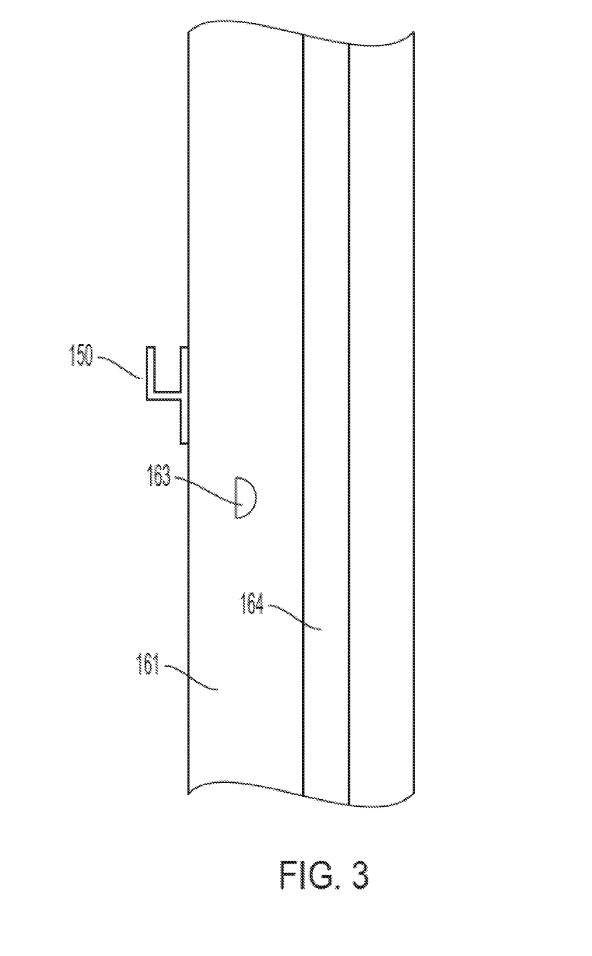

FIG. 3 shows a side view of the wall 161 from the perspective of a person standing in the doorway. The wall includes a cavity 163 for receiving tab 162 and elevated ridge 164 for preventing door 160 from opening outward.

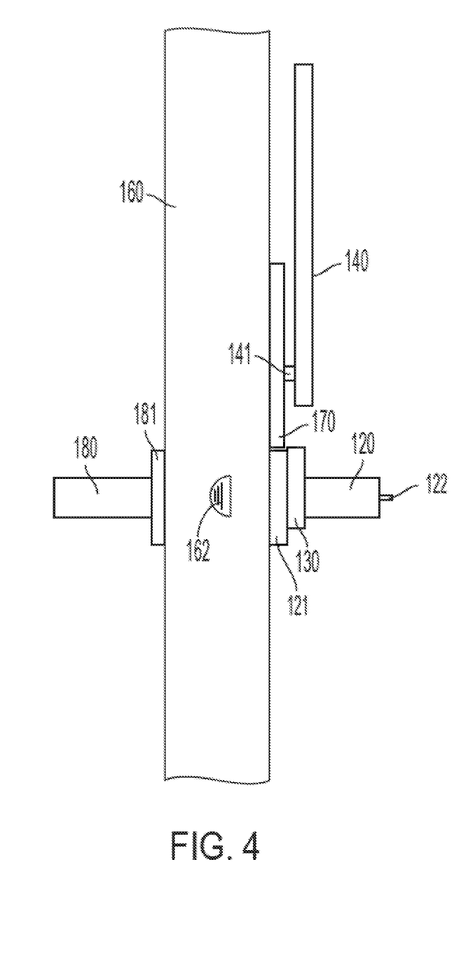

FIG. 4 shows a side view of door 160 from the perspective of someone standing in the doorway. Tab 162 is angled on one side to allow door 160 to be closed without turning first handle 120 or second handle 180. Tab 162 is flat on the other side so that door 160 may not be opened without turning first handle 120 or second handle 180.

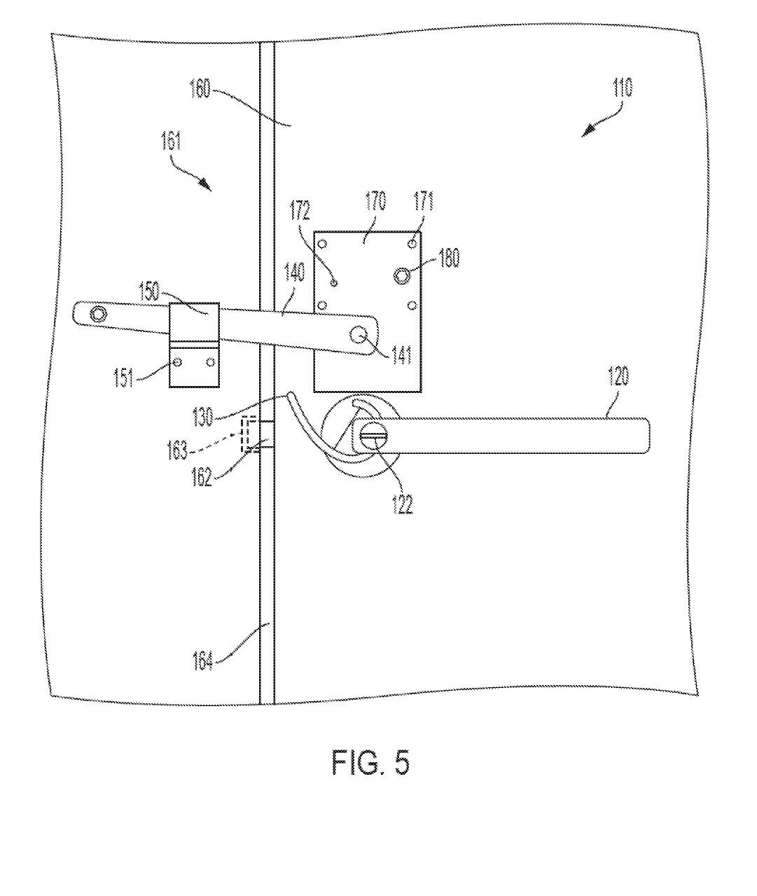

FIG. 5 shows a second front view of the first embodiment of door lock 110. In this view, bar 140 is in the closed position. The user generally moves bar 140 into a closed position by using his hand to rotate bar 140 so that it engages catch 150. In the closed position, bar 140 is engaged with catch 150 to prevent door 160 from opening. A user standing on the near side of door 160 can open door 160 by turning handle 120 and pulling door 160 open. Turning handle 120 disengages tab 162 and cavity 163 and also rotates protrusion 130 to engage bar 140, lifting bar 140 upward. The disengagement of tab 162 and cavity 163 and engagement of protrusion 130 and bar 140 allows the user to pull door 160 open. In this embodiment, the rotation of handle 120 turns bar 140 so that it contacts stop 180 and remains in the open position. The user on the near side of door 160 need only make a single motion to open door 160 when bar 140 is in the closed position. In alternative embodiments, turning handle 120 may raise bar 140 such that bar 140 does not prevent door 160 from opening, but not to the extent that bar 140 contacts stop 180. In those embodiments, bar 140 will return to the closed position until a user places bar 140 in the open position. In still alternative embodiments, mounting plate 170 may include a second stop that limits the downward movement of bar 140 so that bar 140 remains in a closed position and engaged with catch 150. In these embodiment, catch 150 does not limit the downward motion of bar 140 but only prevents the door from being opened and closed when bar 140 is in the closed position.

In the first embodiment, a user standing on the far side of door 160 is generally unable to open door 160 when bar 140 is in the closed position. While the user on the far side of door 160 may be able to rotate second handle 180 on the far side of door 160 to disengage tab 162 and cavity 163, such rotation will not rotate handle 120 to engage protrusion 130 and bar 140, and bar 140 will remain in the closed position. As an optional feature for this embodiment, bar 140 of door lock 110 may be made of a magnetic material so that a user on the far side of door 160 can raise bar 140 and open door 160 with a magnet. As an alternative feature, a key hole is installed through door 160 and mounting plate 170 that allows a user on the far side of door 160 to use a key to lift bar 140 upward so that bar 140 does not prevent door 160 from opening. The rotation of the key may lift bar 140 directly or through a lever or other device.

In alternative embodiments, door 160 swings outward to open. In these embodiments, the door lock works in the same manner as the door lock of the first embodiment, except that bar 140 and catch 150 prevent door 160 from opening outward when bar 140 is in the closed position. As with the door lock of the first embodiment, while a user on the near side of door 160 can open door 160 by rotating handle 120, a user on the far side of door 160 will not be able to open door 160 by rotating second handle 180 on the far side of door 160 when bar 140 is in the closed position.

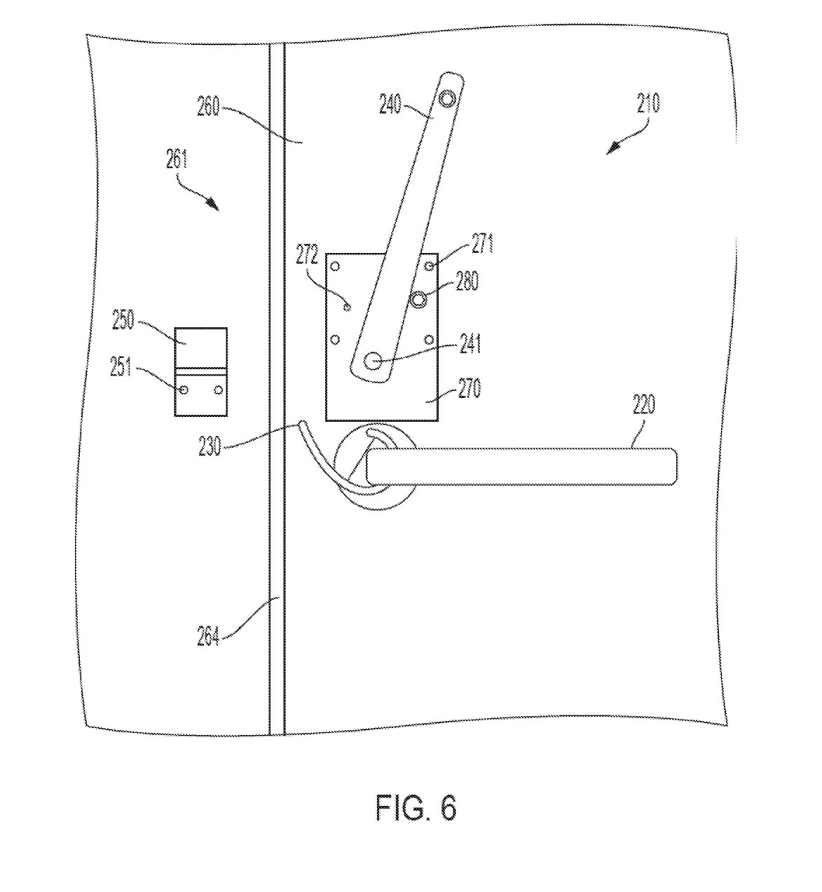

FIG. 6 shows a first front view of a second embodiment of a door lock 210 of the present invention. The components of the door lock 210 are substantially the same as the components of door lock 110, except that it is used on a door that does not have a tab for engaging a cavity in the wall. In this figure, door 260 swings inward to open.

Door lock 210 includes a handle 220, which is movably connected to door 260. A protrusion 230 is affixed to handle 220. Door lock 210 also includes a bar 240 and catch 250. Bar 240 is movably connected to door 260, and catch 250 is affixed to wall 261. In this embodiment, bar 240 is connected to door 260 through mounting plate 270 and pin 241. Mounting plate 270 is affixed to door 260 via screws 271. Mounting plate 270 includes stop 280 and preset hole 272. Catch 250 is affixed to wall 261 via screws 251. Wall 261 includes an elevated ridge 264 that prevents door 260 from opening outward.

When bar 240 is in an open position a user standing on the near side of door 260 can pull door 260 open. When bar 240 is in an open position a user standing on the near side of door 260 can push door 260 shut. When bar 240 is in an open position a user standing on the far side of door 260 can push door 260 open. When bar 240 is in an open position a user standing on the far side of door 260 can pull door 260 shut.

In the closed position, bar 240 is engaged with catch 250 to prevent door 260 from opening. A user standing on the near side of door 260 can open door 260 by turning handle 220 and pulling door 260 open. Turning handle 220 rotates protrusion 230 so that it engages bar 240 and lifts bar 240 upward. Rotating handle 220 engages protrusion 230 and bar 240 and allows the user to pull door 260 open. A user standing on the far side of door 260 is generally unable to open door 260 when bar 240 is in the closed position. While the user on the far side of door 260 may be able to push on door 260, they are not able to rotate handle 220 to engage protrusion 130 and bar 140, and bar 140 will remain in the closed position. In alternative embodiment, door 260 may include a spring or other device that biases door 260 closed. In still further embodiments, mounting plate 270 may include a second stop that limits the downward movement of bar 240 to bar 240's closed position. In further embodiments, catch 250 may be shaped so that if door 260 is closed while bar 240 is in the closed position, catch 250 will lift bar 240 and bar 240 will fall into the closed position when door 260 is completely closed. In these embodiments, bar 240 may engage with catch 250 to prevent door 260 from opening when door 260 is closed by a user.

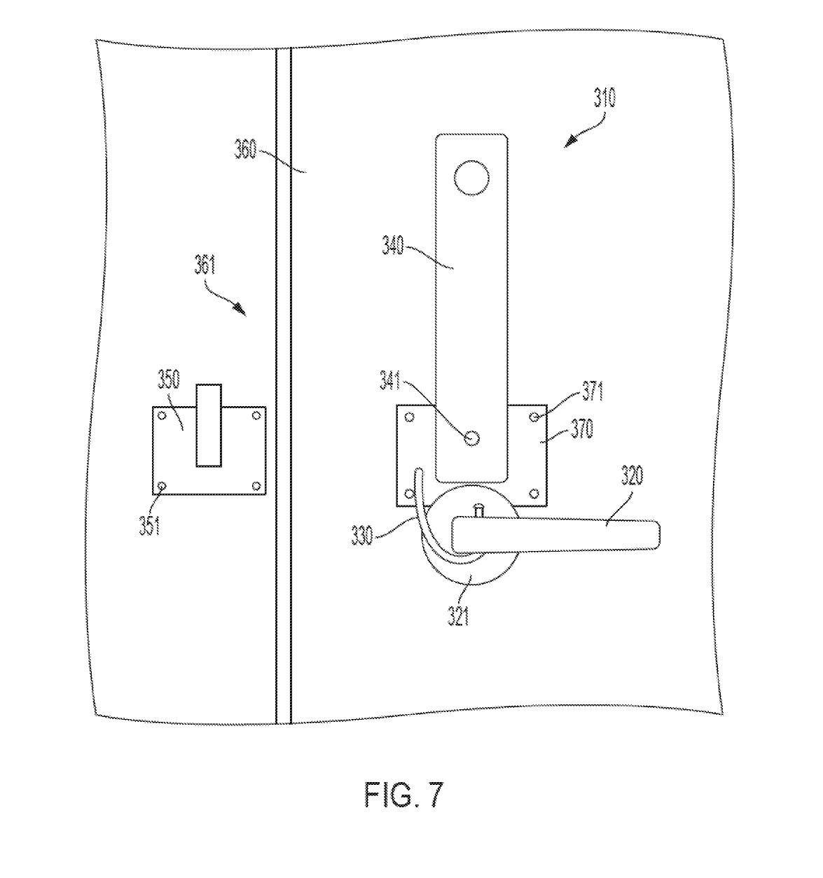

FIG. 7 shows a front view of a third embodiment of door lock 310. In this embodiment, mounting block 370 does not include a stop. Bar 340 is movably attached to door 360 via mounting plate 370 and pin 341. Mounting plate 370 is affixed to door 360 via screws 371. In this embodiment, protrusion 330 is chemically affixed to handle 320. Further, in this embodiment, the catch 350 comprises a simple U-shaped element. Catch 350 is affixed to wall 361 via screws 351. In this embodiment, covering plate 321 covers a portion of mounting plate 370. The remainder of the components of door lock 310 are the same as the components of the door lock 210.

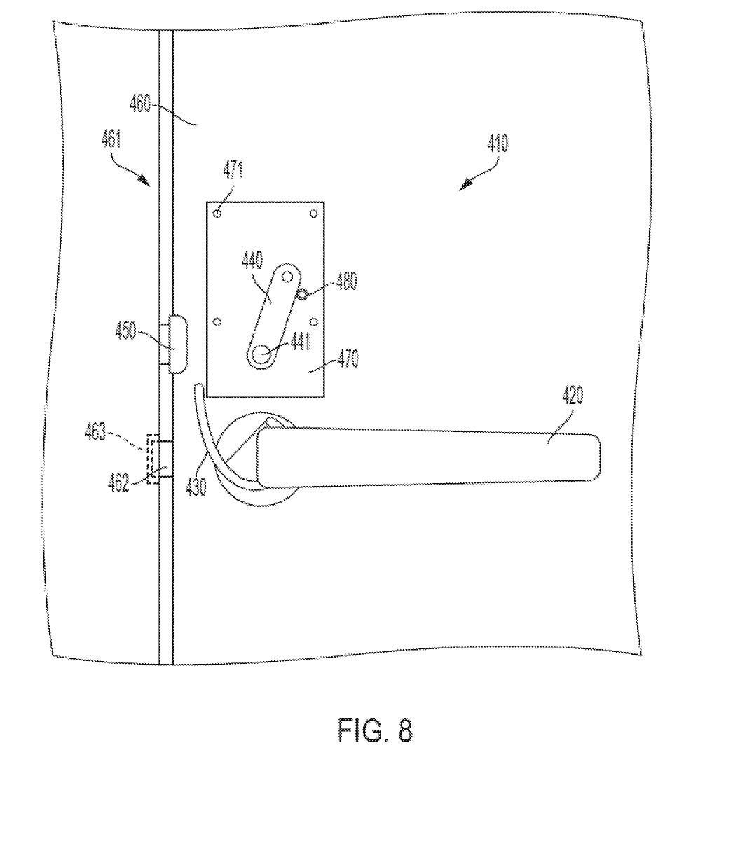

FIG. 8 shows a front view of a fourth embodiment of door lock 410. In this embodiment, door lock 410 is used with a standard door 460. Door 460 includes tab 462 that engages with cavity 463 in wall 461 to prevent door 460 from opening. Door 460 can be opened by rotating handle 420 so that tab 462 is no longer engaged with the cavity 463 and door 460 can be pushed open. In this figure, door 460 swings outward to open.

FIG. 8 shows covering plate 421 and protrusion 430. FIG. 8 also shows mounting plate 470 affixed to door 460 via screws 471. Bar 440 is movably attached to door 460 via mounting plate 470 and pin 441. The components of door lock 410 are similar to the previous door locks, except that bar 440 and catch 450 are modified. In this embodiment, catch 450 is affixed to wall 461 but extends toward door 460. Bar 440 has been shortened.

In FIG. 8, bar 440 is in an open position and does not engage catch 450 to prevent door 460 from opening. Protrusion 430 moves with handle 420 but does not engage bar 440 when bar 440 is in the open position. When bar 440 is in an open position a user standing on the near side of door 460 can turn handle 420 and push door 460 open. When bar 440 is in an open position a user standing on the near side of door 460 can pull door 460 shut. When bar 440 is in an open position a user standing on the far side of door 460 can turn a handle on the far side of door 460 and pull door 460 open. When bar 440 is in an open position a user standing on the far side of door 460 can push door 460 shut.

In the closed position, bar 440 is engaged with catch 450 to prevent door 460 from opening. A user standing on the near side of door 460 can open door 460 by turning handle 420 and pushing door 460 open. Turning handle 420 disengages tab 462 and cavity 463 in wall 461 and also rotates protrusion 430 to engage bar 440, lifting bar 440 upward. The disengagement of tab 462 and cavity 463 and engagement of protrusion 430 and bar 440 allows the user to push door 460 open. In this embodiment, the rotation of handle 420 engages protrusion 430 and bar 440 so that bar 440 contacts stop 480 and remains in the open position. The user on the near side of door 460 need only make a single motion to open door 460 when bar 440 is in the closed position.

In this embodiment, a user standing on the far side of door 460 is generally unable to open door 460 when bar 440 is in the closed position. While the user on the far side of door 460 may be able to rotate a handle on the far side of door 460 to disengage tab 462 and cavity 463 in wall 461, such rotation will not rotate handle 120 to engage protrusion 430 and bar 440, and bar 440 will remain in the closed position

In some embodiments of the invention, the door may include a lock that can be used to further limit who can open and close door 460. Additional embodiments may include a handle and protrusion as a unitary piece. Still further embodiments may include handles of different shapes, such as knobs.

FIGS. 1-5 also depict a method of installing a door lock 110 on an existing door 160. In this embodiment, handle 120 and door 160 are pre-existing. The method includes attaching protrusion 130 to handle 120 of door 160. In this embodiment, protrusion 130 comprises an elongated element. One end of protrusion 130 is wrapped around handle 120, and the other end of protrusion 130 is configured to engage bar 140 when bar 140 is in the closed position and handle 120 is rotated. The end of protrusion 130 that is wrapped around handle 120 may be secured in place by additional components or fasteners or may attached to handle 120 through mechanical or chemical means, such as compressing protrusion 130 onto handle 120, having protrusion 130 penetrate handle 120, using a glue, or welding. In alternative embodiments, protrusion 130 need not be wrapped around handle 120 but may be affixed to handle 120 directly through any of the aforementioned means.

The method also includes attaching bar 140 to door 160. In this embodiment, bar 140 is attached to door 160 through mounting plate 170. The mounting plate 170 includes preset holes that allow the position of stop 180 to be set for different sized doors and doors that are set on either the left or right side. Catch 150 is then affixed to wall 161. The placement of the protrusion 130, mounting plate 170, bar 140 and catch 150 are set so the door can operate for its intended purpose, as described in detail above. By installing the door lock on existing doors, the door locks can be put into wide use easily and cheaply.

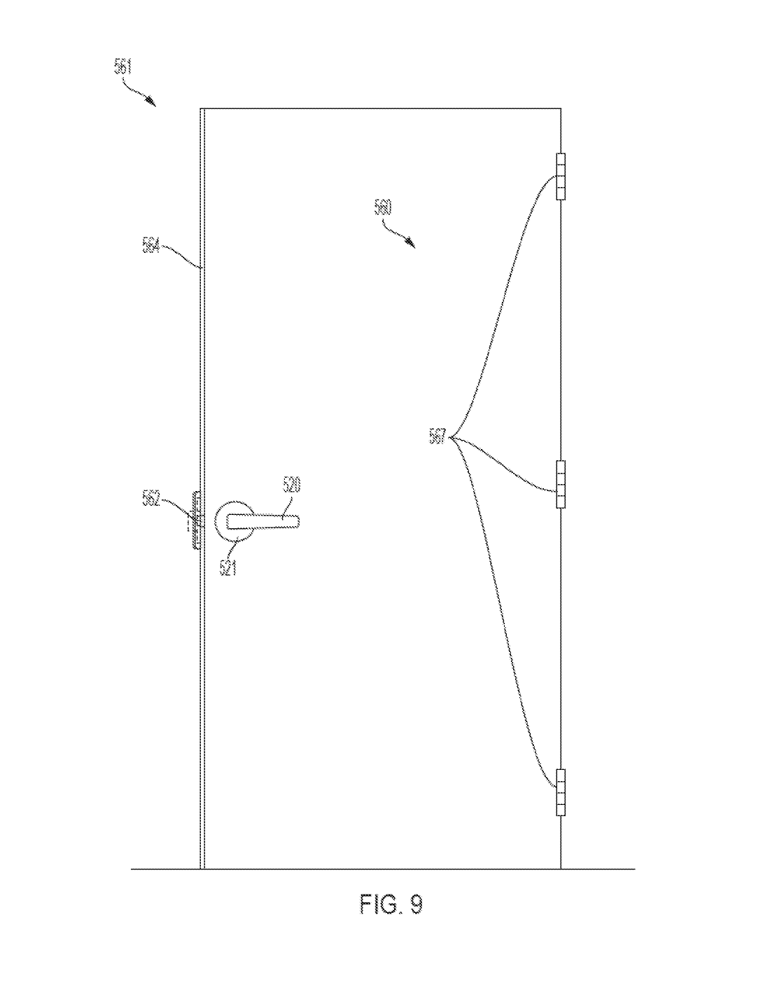

FIG. 9 shows a standard door and wall for use with a door lock. The door 560 includes hinges 567, handle 520, handle cover 521, and retractable tab 562. The wall 561 includes a raised ridge 564 that prevents the door from opening outward.

While the present disclosure has been presented above with respect to the described and illustrated embodiments of a door locking device and with methods for operating and installing door locking devices, it is to be understood that the disclosure is not to be limited to those alternative and described embodiments and preferred embodiments. Various modifications, which will be become apparent to one skill in the art, fall within the scope of this invention including as described in the attached claims.

1. A door locking device comprising:
a first rotatable handle affixed to a first surface of the door;
a rotatable member affixed to the first surface of the door;
a catch affixed to a surface adjacent the door to receive the rotatable member; and
a protrusion from the first rotatable handle that lifts the rotatable member when the rotatable member is engaged with the catch and the first rotatable handle is rotated.

2. The door locking device of claim 1, wherein rotating the first rotatable handle retracts a tab extending from the door allowing the door to be opened.

3. The door locking device of claim 2, wherein rotating a second rotatable handle affixed to a second surface of the door does not cause the protrusion to lift the rotatable member.

4. The door locking device of claim 2, wherein the rotatable member is held in an open position by a stop affixed to the door.

5. The door locking device of claim 4, further comprising:
a mounting plate by which the rotatable member is affixed to the first surface of the door.

6. The door locking device of claim 5, wherein the stop is attached to the mounting plate.

7. The door locking device of claim 6, wherein the stop is positioned to stop the rotatable member so that the rotatable member is extending upward and away from the protrusion.

8. The door locking device of claim 7, wherein the protrusion is mechanically attached to the first rotatable handle.

9. The door locking device of claim 7, wherein the protrusion is chemically attached to the first rotatable handle.

10. The door locking device of claim 7, wherein the protrusion and the first rotatable handle form a unitary component.

11. A device to secure a moveable door, the device comprising:
a movable member affixed to the door, the movable member configured to engage a catch;
a tab extending from the door, the tab configured to engage a cavity; and
a first rotatable handle affixed to the door, rotation of the first rotatable handle retracting the tab so that the tab is no longer engaged with the cavity and moving the movable member so that the movable member is no longer engaged with the catch.

12. The device of claim 11, wherein the moveable door includes a second rotatable handle affixed to the door, rotation of the second rotatable handle retracting the tab so that the tab is no longer engaged with the stationary cavity and the movable member remains engaged with the stationary catch.

13. The device of claim 11, wherein the movable member is rotatably attached to the door and the cavity and catch are stationary with respect to the door.

14. The device of claim 13 wherein the first rotatable handle includes a protrusion, the protrusion moving the movable member so that the movable member is no longer engaged with the stationary catch when the first rotatable handle is rotated.

15. The device of claim 14 wherein the movable member is affixed to the door via a mounting plate.

16. The device of claim 15 wherein the mounting plate includes a stop for stopping the movable member.

17. A method for opening a door comprising:
rotating a rotatable handle affixed to a door, rotation of the rotatable handle retracting a tab that prevents the door from opening and disengaging a member affixed to the door that prevents the door from opening.

18. The method of claim 17 wherein the tab prevents the door from opening by engaging with a cavity.

19. The method of claim 18 wherein the member prevents the door from opening by engaging a catch.

20. The method of claim 19 wherein rotating the rotatable handle lifts the member from the catch.
